(19) United States
(12) Patent Application Publication
(10) Pub. No.: US 2008/0092788 A1
(43) Pub. Date: Apr. 24, 2008

(54) Kind of Desk

(76) Inventor: Luhao Leng, Fujian (CN)

Correspondence Address: GREER, BURNS & CRAIN, 300 S WACKER DR, 25TH FLOOR, CHICAGO, IL, 60606, US

(21) Appl. No.: 11/662,112

(22) PCT Filed: Sep. 7, 2004
(86) PCT No.: PCT/CN04/01024

§ 371 Date: Mar. 6, 2007

(30) Foreign Application Priority Data
Apr. 6, 2004 (CN) 2004200399921.0

(51) Int. Cl. A47B 3/12; A44B 21/00; A47B 7/00; F16M 11/00; A47B 3/06

(52) U.S. Cl. 108/159; 24/455; 248/163.1

(57) ABSTRACT

A kind of desk including: at least a pair of steel legs; a desktop; a pair of steel legs each supports the two ends of the desktop, its character is: the desktop is plastic composite plate, including a board; a bottom board; a honeycomb board and a liner part, the honeycomb board is stuffed between board and bottom board, the liner part is clamped between board and bottom board, and the liner part entirely or partly wraps honeycomb board along the sides of the honeycomb board; both two steel legs vertical to the desktop, and hanging connection or screw thread connection with the desktop.

### FIELD OF THIS INVENTION

This invention relates a kind of desk, more particularly; it relates a kind of desk which is composed of plastic composite plate desktop and steel legs.

### BACKGROUND OF THIS INVENTION

In modern furniture, desks are of practicability, so they are widely used in offices and homes. But the desks are mostly made of wood in the past. As people attach more importance to the ecological environment, the wood acquired from deforestation has been replaced by a plastic plate gradually. The existing desk which is made of the plastic plate, a steel reinforced beam is usually fixed on the under surface of the desktop, the upper end of the leg is connected to the reinforced beam. The above-mentioned desks have following drawbacks: Firstly, a steel reinforced beam is fixed on the desktop, it is a waste of material, the cost of manufacture is high, the weight of the desktop is increased; secondly, if the desktop is solid, its weight will be heavy, if the desktop is hollow, its strength will be low; thirdly, the upper end of the leg is connected to the reinforced beam, its connection strength is not high, and no removable.

### SUMMARY OF THIS INVENTION

The aim of this invention is to resolve the drawbacks of the existing technology and to provide a kind of desk which is light; the connection is high; removable; can be connected expediently.

The technology project according to this invention is: A kind of desk, comprising at least a pair of steel legs; a desktop; a pair of steel legs each supports the two ends of the desktop, its character is: said desktop is plastic composite plate, comprising a board; a bottom board; a honeycomb board and a liner part, the honeycomb board is stuffed between board and bottom board, the liner part is clamped between board and bottom board, and the liner part entirely or partly wraps honeycomb board along the sides of the honeycomb board; both two steel legs vertical to the desktop, and hanging connection or screw thread connection with the desktop.

Said desk according to this invention also comprises front baffle, the front baffle which under the desktop is connected between the two steel legs; the front baffle is plastic composite plate, the plastic composite plate comprises a board; a bottom board; a honeycomb board and a liner part, the honeycomb board is stuffed between board and bottom board, the liner part is clamped between board and bottom board, and the liner part entirely or partly wraps honeycomb board along the sides of the honeycomb board; the connection between said front baffle and said steel leg is hanging connection or screw thread connection.

A reinforcement is planted in both of said desktop and said front baffle, a clasp groove exposes out of plastic composite plate is opened on the reinforcement or a clasp piece convexly extends to the outer surface of plastic composite plate is fixed on the reinforcement, a clasp piece convexly extends to the outer surface of leg plane is correspondingly fixed on the steel leg or a clasp groove exposes out of leg plane is correspondingly opened on the steel leg; the desktop and the front baffle are mutually fixed with steel leg by the clasp piece which is fastened in the clasp groove. The reinforcement is planted in plastic composite plate, the appearance is good, can be processed expediently, the reinforcement is unlikely to scratch user or damage user's clothes, safety to use; the clasp piece or the clasp groove is set on the reinforcement, the strength is high, connection strength is high, can be processed expediently, and will not impact the strength of plastic composite plate; the desk is mainly composed of plastic composite plate and steel leg by hanging connection, the connection is removable connection structure, so it can occupy less space when is stored or conveyed; plastic composite plate and steel leg are mutually fixed by the clasp piece which is fastened in the clasp groove, connection strength is high, hard and reliable.

Said reinforcement according to this invention can be tubular material; section material; injection molding material or metal composite is planted in liner part.

Said reinforcement and said liner part according to this invention are integrative structure, a clasp groove exposes out of plastic composite plate is opened on the liner part or a clasp piece convexly extends to the outer surface of plastic composite plate is fixed on the liner part.

Said board and said bottom board of the plastic composite plate according to this invention both are combinative plastic plate which is processed by vacuum forming technology, the reinforcement and liner part are planted in the plastic composite plate, the paper honeycomb core or plastic honeycomb core or foam filling material is filled in it besides.

Said board and said bottom board of the plastic composite plate according to this invention both are plastic sheets, envelop strips are wrapped along the sides of board and bottom board, the reinforcement and liner part are planted in the plastic composite plate, the paper honeycomb core or plastic honeycomb core or foam filling material is filled in it besides.

Said board and said bottom board of the plastic composite plate according to this invention both are monolayer or multilayer plastic plate which is processed by vacuum forming technology, the thickness of plastic plate is 0.3˜4 mm.

A printing layer or a compound pellicle layer is on said surface of the board and bottom board of the plastic composite plate according to this invention, the printing layer has natural material color of timber or marble, the pellicle layer has natural material color of wood or marble.

Said steel leg according to this invention comprises a top support; a medium support piece and a bottom support, the shape of steel leg is “I” shape; “C” shape; “H” shape; top support; medium support piece and bottom support include steel basic body and terrify lacquer layer; chrome plating layer or zinc plating layer. The structure of said steel leg, its stability is high, its outer layer is terrify lacquer layer; chrome plating layer or zinc plating layer, it is beautiful, can prevent rusting, prolong the life of use; the top support; the medium support piece and the bottom support can be a integrative structure, strength is high, can be processed expediently.

A clasp piece convexly extends to the outer surface of top support plane is fixed on the top support of said steel leg according to this invention, the desktop is plastic composite plate, a reinforcement is planted in it, a clasp groove exposes out of plastic composite plate is opened on the reinforcement, steel leg and desktop are mutually fixed by the clasp piece which is fastened in the clasp groove; a clasp groove exposes out of steel plane is opened on the side of medium support piece of steel leg, the front baffle is plastic composite plate, a reinforcement is planted in it, a clasp piece convexly extends to the outer surface of plastic composite plate is fixed on the reinforcement, the steel leg is mutually fixed with the front baffle by the clasp piece which is fastened in the clasp groove. The clasp groove is opened on said steel leg, the clasp piece is fixed on it, can be processed expediently, manufacture cost is low, and will not impact the strength of steel leg, the clasp groove is opened on the plastic composite, the clasp piece is fixed on the plastic composite, can be processed expediently, manufacture cost is low, and will not impact the strength of plastic composite plate.

Said clasp piece according to this invention can be plastic pothook; sheet metal piece of L shape; sheet piece which is directly blanking to L shape or ladder shape dowel; the clasp groove can be rectangle groove; elliptical groove or ladder groove, the structure of clasp piece and the structure of clasp groove is corresponding. Said clasp piece is plastic pothook; sheet metal piece of L shape; sheet piece which is directly blanking to L shape or ladder shape dowel, manufacture cost is low, can be processed expediently, connection is hard; clasp groove and clasp piece are correspondingly connected hard, connection strength is high.

Said clasp piece of plastic composite plate and said reinforcement which is planted in plastic composite plate according to this invention are fixed by welding connection; rivet connection or screw thread connection. Said clasp piece and said reinforcement are connected by welding connection; rivet connection or screw thread connection, can be processed expediently, connection is hard.

The connection between said plastic composite plate and said steel leg according to this invention is L shape; T shape or “-” shape. The connection strength between plastic composite plate and steel leg is high.

As the description above, compared with background technology, this invention has the following advantages: Firstly, the weight of the desk is light, strength is high; secondly, each of the strength of plastic composite plate is high; thirdly, the connection between desktop; front baffle and steel leg is high, can be connected expediently; fourthly, the reinforcement is planted in plastic composite plate, the appearance is good, can be processed expediently, the reinforcement is unlikely to scratch user or damage user's clothes, safety to use; fifthly, the connection of the desk is removable connection, so it can occupy less space when is stored or conveyed; sixthly, the liner part can be used as reinforcement directly if it is necessary.

### BRIEF DESCRIPTION OF THE DRAWINGS

FIG. 1 is the stereogram of the embodiment 1;

FIG. 2 is the sectional view of plastic composite plate of the embodiment 1;

FIG. 3 is the stereogram of steel leg of embodiment 1;

FIG. 4 is the partial elevational view of the embodiment 1;

FIG. 5 is the partial bottom view of embodiment 1;

FIG. 6 is the partial left side view of front baffle of embodiment 1;

FIG. 7 is the sectional view of first clasp piece which is fastened in first clasp groove of embodiment 1;

FIG. 8 is the top view of first clasp groove of the embodiment 1;

FIG. 9 is the sectional view of second clasp piece which is fastened in second clasp groove of the embodiment 1;

FIG. 10 is the elevational view of second clasp groove of the embodiment 1;

FIG. 11 is the sectional view of second clasp piece which is fastened in second clasp groove of the embodiment 2;

FIG. 12 is the elevational view of second clasp groove of the embodiment 2;

FIG. 13 is the sectional view of second clasp piece which is fastened in second clasp groove of the embodiment 3;

FIG. 14 is the elevational view of second clasp piece of the embodiment 3;

FIG. 15 is the elevational view of second clasp groove of the embodiment 3; and

FIG. 16 is the sectional view of plastic composite plate of the embodiment 4.

### DETAILED DESCRIPTION OF THE PREFERRED EMBODIMENTS

### Embodiment 1

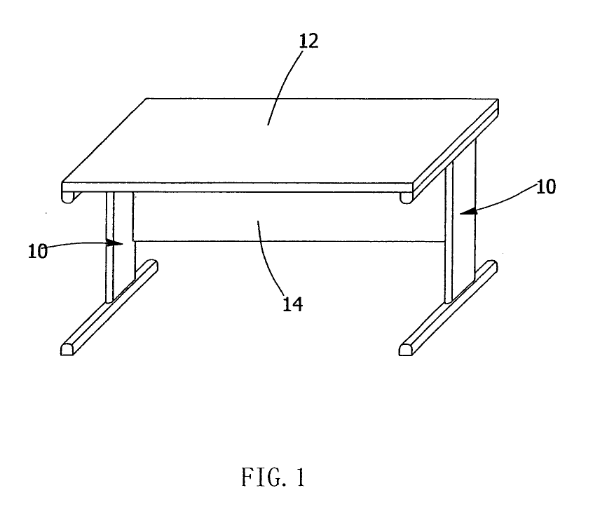

A kind of desk, as shown in FIG. 1, comprising two steel legs 10; a desktop 12 and a front baffle 14, the upper ends of two steel legs 10 are respectively connected to the left side and right side of the bottom board 10 of desktop 12, the back side of two steel legs 10 is respectively connected to the left side and right side of front baffle 14. The connection between desktop 12 and two steel legs 10 is hanging connection; the connection between front baffle 14 and two steel legs 10 is hanging connection.

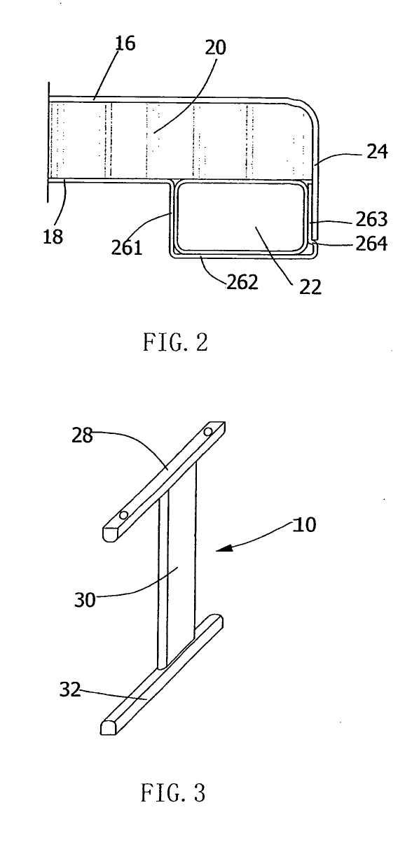

As shown in FIG. 1; FIG. 2, desktop 12 and front baffle 14 both are plastic composite plates, comprising a board 16; a bottom board 18; a honeycomb board 20; and a liner part 22, the honeycomb board 20 is stuffed between board 16 and bottom board 18. Board 16 and bottom board 18 both are made of plastic composite plate, which is processed by vacuum forming technology, the thickness of the combinative plastic plate is 0.3˜4 mm. The sides of bottom board 18 downwardly extends to form a first lower wrap line 261, the down side of first lower wrap line 261 laterally extends to form a second lower wrap line 262, the outer surface of second lower wrap line 262 upwardly extends to form a third lower wrap line 263, a step 264 is set on the third lower wrap line 263. The sides of board 16 downwardly extends to form an upper wrap line 24. The inner side of upper wrap line 24 is stuck to the outer surface of honeycomb board 20 and the portion which is higher than the step of third lower wrap line 263. Upper wrap line 24 of plastic composite plate is adjacent to the lower portion of third lower wrap line 263. The overlapped line of board 16 and bottom board 18 is located at the bottom of plastic composite plate. A printing layer is on the surface of the board 16 and bottom board 18 of the plastic composite plate, the printing layer has natural material color of timber or marble. The first lower wrap line 261; the second lower wrap line 262 and the third lower wrap line 263 form a groove, the liner part 22 is fixed in the groove.

As shown in FIG. 3, the steel leg 10 comprises a top support 28; a medium support piece 30 and a bottom support 32, the upper end and lower end of medium support piece 30 are respectively fixed on the lower side of top support 28 and the upper side of bottom support 32. The shape of steel leg 10 is “I” shape; top support 28; medium support piece 30 and bottom support 32 include steel basic body and terrify lacquer layer; chrome plating layer or zinc plating layer. The steel basic body can be hollow if it is necessary.

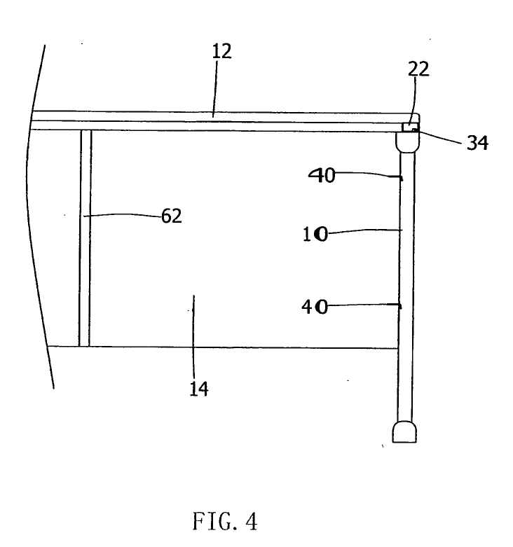

As shown in FIG. 4; FIG. 5, two first clasp pieces 34 convexly extend to the outer surface of top support plane are fixed on the two top supports 28 of steel leg 10, desktop 12 is plastic composite plate, first reinforcements 36 are planted in its left side and right side, the two first reinforcements 36 are both opened on two first clasp grooves 38 expose out of plastic composite plate, steel leg 10 and desktop 12 are mutually fixed by first clasp piece 34 which is fastened in corresponding first clasp groove 38. The first reinforcement 36 can be tubular material; section material; Injection molding material or metal composite planted in liner part 22.

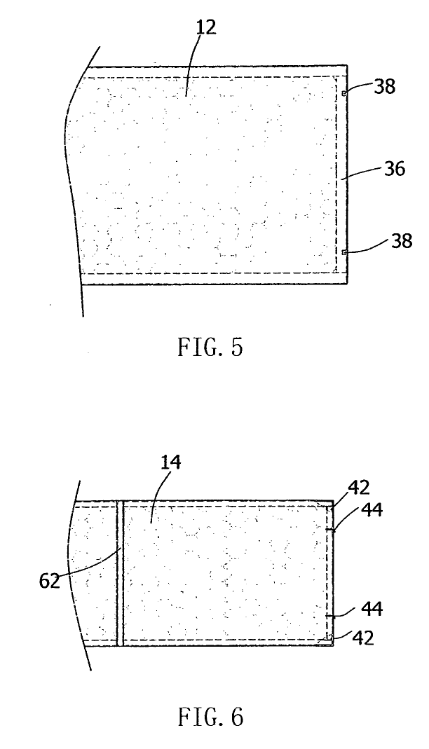

As shown in FIG. 4; FIG. 6, two second clasp grooves 40 expose out of plate plane are opened on the two medium support pieces 30 of steel leg 10, front baffle 14 is plastic composite plate, second reinforcement 42 is planted in the left side and right side of front baffle 14, two second clasp pieces 44 convexly extend to the outer surface of plastic composite plate are both fixed on the two second reinforcements 42, steel leg 10 and front baffle 14 are mutually fixed by second clasp piece 44 which is fastened in corresponding second clasp groove 40. Second reinforcement 42 can be tubular material; section material; injection molding material or metal composite. An assistant support part 62 is fixed between the two second reinforcements 42.

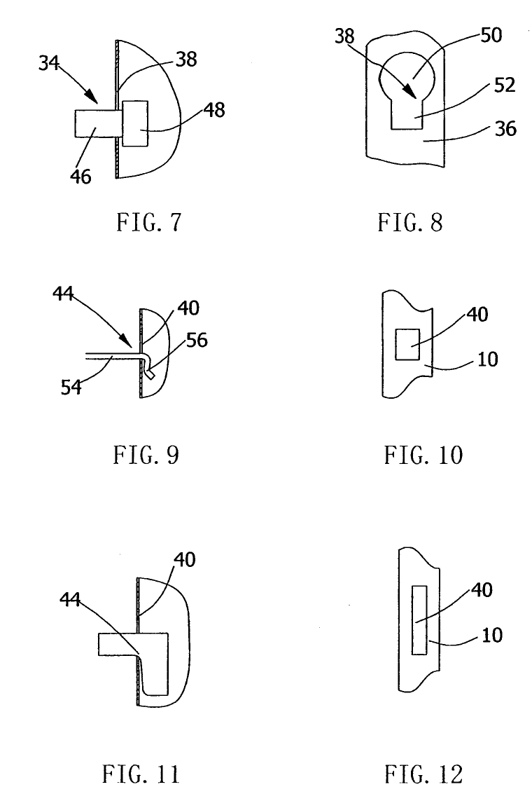

As shown in FIG. 7: FIG. 8, first clasp piece 34 is ladder shape dowel, comprising a connection pole 46 which is connected to steel leg 10, and a clasp pole 48 which is connected to the end of connection pole 46, the diameter of clasp pole 48 is longer than connection pole's 46. First clasp piece 34 is welded to steel leg 10. First clasp groove 38 is ladder groove, comprising a round hole groove 50 and an orientation groove 52 whose diameter is shorter than the round hole groove 50. The diameter of round hole groove 50 is longer than clasp pole's 48; the diameter of connection pole 46 is shorter than the width of orientation groove 50.

As shown in FIG. 9; FIG. 10, the second clasp piece 44 comprising connection pole 54 which is connected to second reinforcement 42 and clasp pole 56 which is connected to the end of connection pole 54. The angle range between clasp pole 56 and connection pole 54 is 90˜150, and clasp pole 56 is similar to S shape. Second clasp piece 44 is welded to second reinforcement 42. Second clasp groove 40 is a rectangle groove.

### Embodiment 2

The difference between the embodiment 2 and the embodiment 1 is: As shown in FIG. 11; FIG. 12, second clasp piece 44 is L shape, first clasp piece 44 is welded to second reinforcement 42; second clasp groove 40 is a rectangle groove.

### Embodiment 3

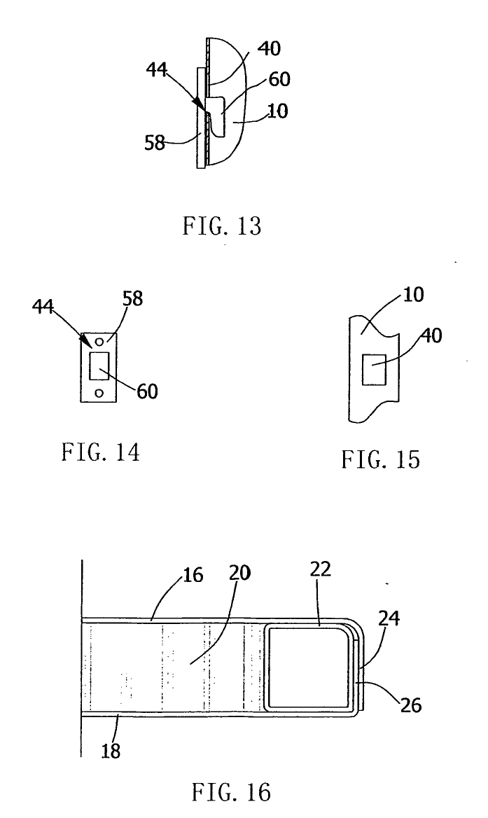

The difference between the embodiment 3 and the embodiment 1 is: As shown in FIG. 13; FIG. 14; FIG. 15, second clasp piece 44 is plastic pothook, comprising an orientation piece 58 and a clip hook 60 which is fixed on orientation piece 58; orientation piece 58 is riveted to second reinforcement 42; second clasp groove 40 is a rectangle groove.

### Embodiment 4

The difference between the embodiment 4 and the embodiment 1 is: As shown in FIG. 16, the desktop 12 and front baffle 14 are plastic composite plate, comprising a board 16; a bottom board 18; a honeycomb board 20; and a liner part 22, the honeycomb board 20 is stuffed between board 16 and bottom board 18, the liner part 22 is clamped between board 16 and bottom board 18, and the liner part 22 entirely wraps honeycomb board 20 along the sides of the honeycomb board 20. First reinforcement 36 and second reinforcement 42 both are integrative structures with liner part 22; the board 16 and bottom board 18 of the plastic composite plate both are monolayer or multilayer plastic plate which is processed by means of suction molding, the thickness of plastic plate is 0.3˜4 mm. The sides of board 16 downwardly extends to form an upper wrap line 24, the sides of bottom board 18 downwardly extends to form a down wrap line 26. The inside of upper wrap line 24 is stuck to the outer surface of down wrap line 26, namely the overlapped line of board 16 and bottom board 18 is located at the bottom plastic composite plate. A printing layer is on the surface of the board 16 and bottom board 18 of the plastic composite plate, the printing layer has natural material color of timber or marble.

As mentioned above, they are preferred embodiments of the present invention; it does not limit the scope of the present invention. The equivalent change and the modification based on the contents of the technical project and the specification of the present invention are belonging to the scope of the present utility model.

### INDUSTRIAL APPLICABILITY

This invention is a kind of desk, comprising a pair of steel legs; a plastic composite desktop, the connection of steel leg and desktop is hanging connection or screw thread connection, the structure is simple and removable, the components thereof can be mass produced, so the desk has industrial applicability.

1. A kind of desk comprising: at least a pair of steel legs; a desktop; a pair of steel legs each supports the two ends of the desktop, its character is: said desktop is plastic composite plate, comprising a board; a bottom board; a honeycomb board and a liner part, the honeycomb board is stuffed between board and bottom board, the liner part is clamped between board and bottom board, and the liner part entirely or partly wraps honeycomb board along the sides of the honeycomb board; both two steel legs vertical to the desktop, and hanging connection or screw thread connection with the desktop.

2. The kind of desk of claim 1, wherein said desk also comprises a front baffle, the front baffle which under the desktop is connected between the two steel legs; the front baffle is plastic composite plate, the plastic composite plate comprises a board; a bottom board; a honeycomb board and a liner part, the honeycomb board is stuffed between board and bottom board, the liner part is clamped between board and bottom board, and the liner part entirely or partly wraps honeycomb board along the sides of the honeycomb board; the connection between said front baffle and said steel leg is hanging connection or screw thread connection.

3. The kind of desk of claim 1, wherein a reinforcement is planted in both of said desktop and said front baffle, a clasp groove expose out of plastic composite plate is opened on the reinforcement or a clasp piece convexly extends to the outer surface of plastic composite plate is fixed on the reinforcement, a clasp piece convexly extends to the outer surface of leg plane is correspondingly fixed on the steel leg or a clasp groove expose out of leg plane is correspondingly opened on the steel leg; the desktop and the front baffle are mutually fixed with steel leg by the clasp piece which is fastened in the clasp groove.

4. The kind of desk of claim 3, wherein said reinforcement can be tubular material; section material; injection molding material or metal composite is planted in liner part.

5. The kind of desk of claim 3, wherein said reinforcement and said liner part are integrative structure, a clasp groove exposes out of plastic composite plate is opened on the liner part or a clasp piece convexly extends to the outer surface of plastic composite plate is fixed on the liner part.

6. The kind of desk of claim 3, wherein said clasp piece can be plastic pothook; sheet metal piece of L shape; sheet piece which is directly blanking to L shape or ladder shape dowel; the clasp groove can be rectangle groove; elliptical groove or ladder groove, the structure of clasp piece and the structure of clasp groove is corresponding.

7. The kind of desk of claim 3, wherein said clasp piece of plastic composite plate and said reinforcement which is planted in plastic composite plate are fixed by welding connection; rivet connection or screw thread connection.

8. The kind of desk of claim 3, wherein the connection between said plastic composite plate and said steel leg is L shape; T shape or “-” shape.

9. The kind of desk of claim 1, wherein said board and said bottom board of the plastic composite plate both are combinative plastic plate which is processed by vacuum forming technology, the reinforcement and liner part are planted in the plastic composite plate, the paper honeycomb core or plastic honeycomb core or foam filling material is filled in it besides; or said board and said bottom board of the plastic composite plate both are plastic sheets, envelop strips are wrapped along the sides of board and bottom board, the reinforcement and liner part are planted in the plastic composite plate, the paper honeycomb core or plastic honeycomb core or foam filling material is filled in it besides; or said board and said bottom board of the plastic composite plate both are monolayer or multilayer plastic plate which is processed by vacuum forming technology, the thickness of plastic plate is 0.3˜4 mm.

10. The kind of desk of claim 9, wherein a printing layer or a compound pellicle layer is on said surface of the board and bottom board of the plastic composite plate, the printing layer has natural material color of timber or marble, the pellicle layer has natural material color of wood or marble.

11. The kind of desk of claim 1, wherein said steel leg comprises a top support; a medium support piece and a bottom support, the shape of steel leg is “I” shape; “C” shape; “H” shape; top support; medium support piece and bottom support include steel basic body and terrify lacquer layer; chrome plating layer or zinc plating layer.

12. The kind of desk of claim 8, wherein a clasp piece convexly extends to the outer surface of top support plane is fixed on the top support of said steel leg, the desktop is plastic composite plate, a reinforcement is planted in it, a clasp groove expose out of plastic composite plate is opened on the reinforcement, steel leg and desktop are mutually fixed by the clasp piece which is fastened in the clasp groove; a clasp groove exposes out of steel plane is opened on the side of medium support piece of steel leg, the front baffle is plastic composite plate, a reinforcement is planted in it, a clasp piece convexly extends to the outer surface of plastic composite plate is fixed on the reinforcement, the steel leg is mutually fixed with the front baffle by the clasp piece which is fastened in the clasp groove.
